(19) United States
(12) Patent Application Publication
(10) Pub. No.: US 2011/0045800 A1
(43) Pub. Date: Feb. 24, 2011

(54) COMMUNICATION SYSTEM, CONTROL METHOD THEREFOR, BASE STATION, AND COMPUTER-READABLE STORAGE MEDIUM

(75) Inventor: Ryuuichi Yoneyama, Sagamihara-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/846,916

(22) Filed: Jul. 30, 2010

(30) Foreign Application Priority Data
Aug. 20, 2009 (JP) 2009-191472

(51) Int. Cl. H04M 1/66

(52) U.S. Cl. 455/411; 455/432.1

(57) ABSTRACT

A communication apparatus transmits an authentication request to a base station. The base station holds information which associates identification information of a communication apparatus of a user authorized to use a roaming service with a roaming provider corresponding to the communication apparatus, and determines a roaming provider as a roaming destination of the communication apparatus as an authentication request source based on the identification information of the communication apparatus as an authentication request source contained in the authentication request and the held information. The base station then redirects communication of the communication apparatus as an authentication request source to the authentication server of the roaming provider based on a determination result.

### BACKGROUND OF THE INVENTION

1. Field of the Invention

The present invention relates to a communication system, a control method therefor, a base station, and a computer-readable storage medium.

2. Description of the Related Art

A public wireless LAN (Local Area Network) service is known as a wireless communication technique. The public wireless LAN service enables a user to connect to a network (for example, the Internet) by using an information apparatus even when the user is out. To use the public wireless LAN service, the user needs to subscribe to the service provided by a public wireless LAN service provider. Then, the user uses subscription information such as an issued user account to utilize the service.

In the public wireless LAN service, a roaming service is well known. Assume that public wireless LAN service providers are in partnership with each other, and the user has subscribed to a service provided by an arbitrary provider among the providers. In this case, the roaming service enables the user to use the public wireless LAN service in the area covered by those partner providers. A public wireless LAN service provider to which the user has subscribed will be referred to as “user subscription provider”; and a roaming service provider available to the user, “roaming provider”, hereinafter.

With respect to the above-mentioned roaming service, a technique described in Japanese Patent Laid-Open No. 2004-88424 is well known. In this technique, the identification information of a user subscription provider and that of a roaming provider are stored in advance, and those pieces of information are compared with the identification information of a provider acquired from a base station. Based on a comparison result, whether the coverage area in question is of the user subscription provider or the roaming provider is displayed.

To use the roaming service, a user needs to check a roaming provider in partnership with the provider to which the user has subscribed, and preset, in the information apparatus, information necessary for connecting to the roaming provider. As the number of available roaming providers increases, therefore, the coverage area expands and the convenience of the user improves. However, the burden of the above setting increases accordingly.

### SUMMARY OF THE INVENTION

The present invention provides a technique for simplifying a user operation to use the roaming service.

According to one aspect of the present invention, there is provided a communication system comprising a base station and a communication apparatus for making communication via the base station, the communication apparatus comprising: an authentication request transmission unit configured to transmit, to the base station, an authentication request which contains identification information for identifying the communication apparatus and requests authentication to an authentication server of a roaming provider which provides a roaming service, and the base station comprising: a first holding unit configured to hold information which associates identification information of a communication apparatus of a user authorized to use the roaming service with a roaming provider corresponding to the communication apparatus; a roaming destination determination unit configured to determine a roaming provider as a roaming destination of the communication apparatus as an authentication request source based on the identification information of the communication apparatus as an authentication request source contained in the authentication request, and the information held in the first holding unit; and a redirection unit configured to redirect communication of the communication apparatus as an authentication request source to an authentication server of the roaming provider determined by the roaming destination determination unit.

According to another aspect of the present invention, there is provided a control method for a communication system comprising a base station and a communication apparatus for making communication via the base station, the method comprising: transmitting, by the communication apparatus, to the base station, an authentication request which contains identification information for identifying the communication apparatus and requests authentication to an authentication server of a roaming provider which provides a roaming service; holding, by the base station, information which associates identification information of a communication apparatus of a user authorized to use the roaming service with a roaming provider corresponding to the communication apparatus; determining, by the base station, a roaming provider as a roaming destination of the communication apparatus as an authentication request source based on the identification information of the communication apparatus as an authentication request source contained in the authentication request, and the held information; and redirecting, by the base station, communication of the communication apparatus as an authentication request source to an authentication server of the roaming provider determined as the roaming destination.

According to still another aspect of the present invention, there is provided a base station for relaying communication of a communication apparatus, comprising: a first holding unit configured to hold information which associates identification information of a communication apparatus of a user authorized to use a roaming service with a roaming provider corresponding to the communication apparatus; an authentication request reception unit configured to receive an authentication request which contains identification information for identifying the communication apparatus and requests authentication to an authentication server of a roaming provider which provides the roaming service; a roaming destination determination unit configured to determine a roaming provider as a roaming destination of the communication apparatus as an authentication request source based on the identification information of the communication apparatus as an authentication request source contained in the authentication request, and the information held in the first holding unit; and a redirection unit configured to redirect communication of the communication apparatus as an authentication request source to an authentication server of the roaming provider determined by the roaming destination determination unit.

According to yet another aspect of the present invention, there is provided a computer-readable storage medium storing a computer program for causing a computer incorporated in a base station which relays communication of a communication apparatus to function as: a first holding unit configured to hold information which associates identification information of a communication apparatus of a user authorized to use a roaming service with a roaming provider corresponding to the communication apparatus; an authentication request reception unit configured to receive an authentication request which contains identification information for identifying the communication apparatus and requests authentication to an authentication server of a roaming provider which provides the roaming service; a roaming destination determination unit configured to determine a roaming provider as a roaming destination of the communication apparatus as an authentication request source based on the identification information of the communication apparatus as an authentication request source contained in the authentication request, and the information held in the first holding unit; and a redirection unit configured to redirect communication of the communication apparatus as an authentication request source to an authentication server of the roaming provider determined by the roaming destination determination unit.

Further features of the present invention will become apparent from the following description of exemplary embodiments with reference to the attached drawings.

### BRIEF DESCRIPTION OF THE DRAWINGS

FIG. 1 is a block diagram showing an example of the whole configuration of a communication system according to an embodiment of the present invention;

FIG. 2 is a block diagram showing an example of the functional arrangement of a communication apparatus 101 shown in FIG. 1;

FIG. 3 is a block diagram showing an example of the functional arrangement of a base station 102 shown in FIG. 1;

FIG. 4 is a flowchart showing an example of the operation of the communication apparatus 101 shown in FIG. 1;

FIG. 5 is a flowchart showing an example of the operation of the base station 102 shown in FIG. 1; and

FIG. 6 is a flowchart showing an example of the operation of the base station 102 shown in FIG. 1.

### DESCRIPTION OF THE EMBODIMENTS

An exemplary embodiment(s) of the present invention will now be described in detail with reference to the drawings. It should be noted that the relative arrangement of the components, the numerical expressions and numerical values set forth in these embodiments do not limit the scope of the present invention unless it is specifically stated otherwise.

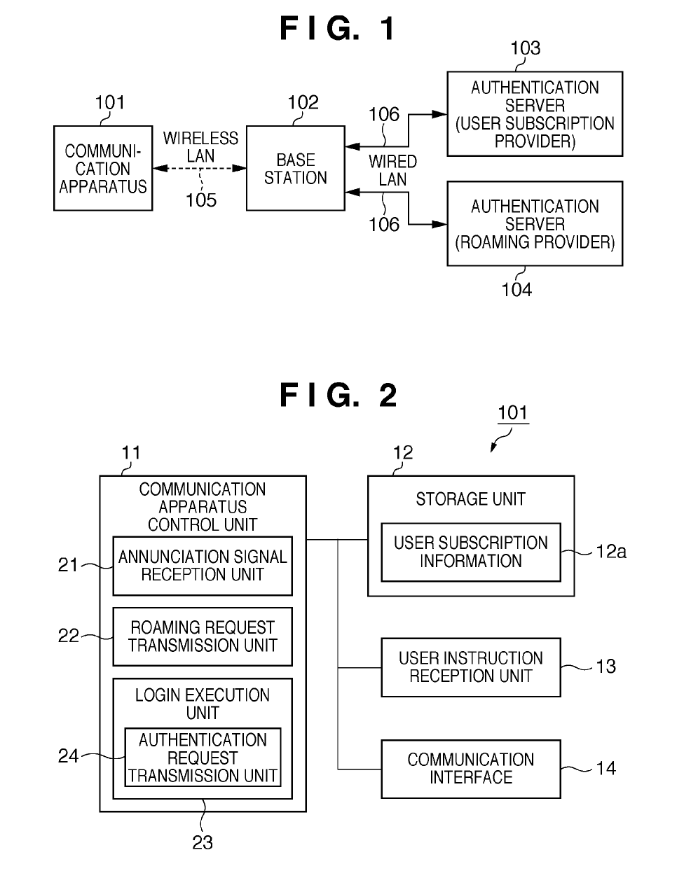

FIG. 1 is a block diagram showing an example of the whole configuration of a communication system according to an embodiment of the present invention. This communication system includes a communication apparatus 101, a base station 102, and authentication servers 103 and 104.

The authentication server 103 serves as a login server of a public wireless LAN service provider to which a user has subscribed (a user subscription provider). In other words, the authentication server 103 functions as an authentication server of a provider to which the base station 102 belongs. The authentication server 104 serves as a login server of a roaming service provider (a roaming provider).

The communication apparatus 101 makes communication via the public wireless LAN service. In this embodiment, assume that the user using the communication apparatus 101 has subscribed to the user subscription provider to use the public wireless LAN service. Assume also that the user has set, in the communication apparatus 101 in advance, user account information (user subscription information) issued by the user subscription provider in the subscription.

The base station 102 relays communication between the communication apparatus 101 and the authentication servers 103 and 104. The communication is relayed via, for example, a wireless LAN or wired LAN. In this embodiment, the communication apparatus 101 and the base station 102 are connected via, for example, a wireless LAN 105. Furthermore, the base station 102 and the authentication servers 103 and 104 are connected via, for example, a wired LAN 106. Note that the communication units between the apparatuses are merely examples and the apparatuses may be connected with each other by using another communication unit.

Although an example of the whole configuration of the communication system has been explained above, the configuration of the communication system is merely an example, and is not limited to it. A plurality of authentication servers 103 or 104 may exist, for example.

The above-described communication apparatus 101, base station 102, and authentication servers 103 and 104 respectively incorporate a computer. The computer has a main control unit such as a CPU, and a storage unit such as a ROM (Read Only Memory), a RAM (Random Access Memory), and an HDD (Hard Disk Drive). In addition to them, the computer includes an input/output unit such as a keyboard, a mouse, a display, a button, or a touch panel. These component units are connected with each other via a bus or the like, and are controlled by executing programs stored in the storage unit by the main control unit.

FIG. 2 is a block diagram showing an example of the functional arrangement of the communication apparatus 101 shown in FIG. 1.

The communication apparatus 101 includes a communication apparatus control unit 11, a storage unit 12, a user instruction reception unit 13, and a communication interface 14.

The communication apparatus control unit 11 controls the entire communication apparatus 101, and has an annunciation signal reception unit 21, a roaming request transmission unit 22, and a login execution unit 23.

The annunciation signal reception unit 21 receives a roaming providing advertisement annunciation signal (to be simply referred to as an annunciation signal hereinafter) from the base station 102. The roaming request transmission unit 22 transmits, to the base station 102, a roaming request for requesting to use the roaming service. The roaming request contains, for example, user account information (user subscription information 12a) and the identification information of the communication apparatus 101.

The login execution unit 23 executes login processing to the authentication server 104 of the roaming provider. The login execution unit 23 has an authentication request transmission unit 24. The authentication request transmission unit 24 transmits, to the base station 102, an authentication request for requesting authentication to the authentication server 104 of the roaming provider. The authentication request contains, for example, the identification information of the communication apparatus 101.

The storage unit 12 stores various kinds of information. The storage unit 12 stores, for example, the user subscription information 12a about the user of the communication apparatus 101. The user subscription information 12a is, for example, user account information. The user instruction reception unit 13 receives a user instruction input. The user instruction is input through, for example, a button or touch panel. The user instruction reception unit 13 receives, for example, a user instruction associated with setting of the user subscription information 12a. The communication interface 14 controls wireless communication.

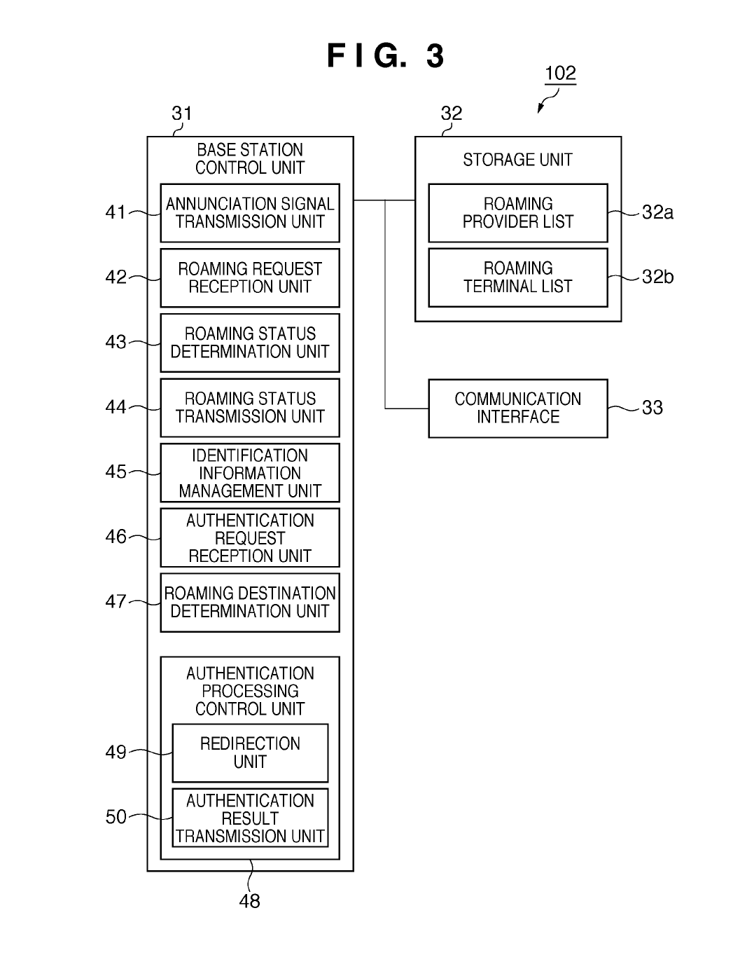

FIG. 3 is a block diagram showing an example of the functional arrangement of the base station 102 shown in FIG. 1.

The base station 102 includes a base station control unit 31, a storage unit 32, and a communication interface 33.

The base station control unit 31 controls the entire base station 102. The base station control unit 31 includes an annunciation signal transmission unit 41, a roaming request reception unit 42, a roaming status determination unit 43, a roaming status transmission unit 44, an identification information management unit 45, an authentication request reception unit 46, a roaming destination determination unit 47, and an authentication processing control unit 48.

The annunciation signal transmission unit 41 transmits an annunciation signal. The annunciation signal serves to notify the communication apparatus 101 of a roaming service providing status. The roaming request reception unit 42 receives an authentication request from the communication apparatus 101.

The roaming status determination unit 43 determines whether to permit the communication apparatus 101 (more particularly, the user of the communication apparatus 101) to use the roaming service. This determination is made based on the user subscription information 12a (contained in the roaming request) received from the roaming request reception unit 42, and a roaming provider list 32a stored in the storage unit 32. More specifically, the subscription provider of the user using the communication apparatus 101 is identified by comparing both the pieces of information to determine whether the user can use the roaming service. The roaming status transmission unit 44 transmits, as a response (an inquiry response) to the roaming request, a determination result from the roaming status determination unit 43 to the communication apparatus 101 as a roaming request source. In addition to the information indicating roaming service status, this response contains connection parameters for connecting to the base station 102, and the like.

The identification information management unit 45 manages identification information for uniquely identifying the communication apparatus 101. The unit 45 manages the information using a roaming terminal list 32b stored in the storage unit 32. Note that although a MAC (Media Access Control) address is used as the identification information for uniquely identifying the communication apparatus 101, the identification information is not limited to this, and any information which can uniquely identify the communication apparatus 101 may be used.

The authentication request reception unit 46 receives an authentication request from the communication apparatus 101. The roaming destination determination unit 47 determines a roaming provider serving as a roaming destination of the communication apparatus 101 as an authentication request source, based on the identification information of the communication apparatus 101 as an authentication request source contained in the authentication request, and information held in the roaming terminal list 32b.

The authentication processing control unit 48 controls execution of authentication processing necessary for the communication apparatus 101 to use the public wireless LAN service. The authentication processing control unit 48 controls execution of login authentication processing of the communication apparatus 101 to the authentication server 104 of a roaming provider based on a determination result from the roaming destination determination unit 47. The authentication processing control unit 48 includes a redirection unit 49, and an authentication result transmission unit 50. The redirection unit 49 redirects communication of the communication apparatus 101 as an authentication request source. The authentication server 104 (a login authentication page) of the roaming provider determined by the roaming destination determination unit 47 is an example of a redirection destination. The authentication result transmission unit 50 transmits, to the communication apparatus 101 as an authentication request source, a result of the authentication processing executed in response to the redirection by the redirection unit 49.

The communication interface 33 controls communication with the communication apparatus 101 and the authentication servers 103 and 104. The communication interface 33 controls communication with each apparatus using a wireless LAN, a wired LAN, or the like.

The storage unit 32 stores various kinds of information. The storage unit 32 stores, for example, the roaming provider list 32a and the roaming terminal list 32b. The roaming terminal list 32b functions as the first holding unit, and holds, for example, information which associates the identification information of the communication apparatus 101 of the user authorized or entitled to use the roaming service with a roaming provider corresponding to the apparatus. The roaming provider list 32a functions as the second holding unit, and holds information indicating a roaming service partnership between the providers. This information contains the identifier (for example, @example.co.jp) of each provider, and an address used by the communication apparatus 101 to execute authentication processing.

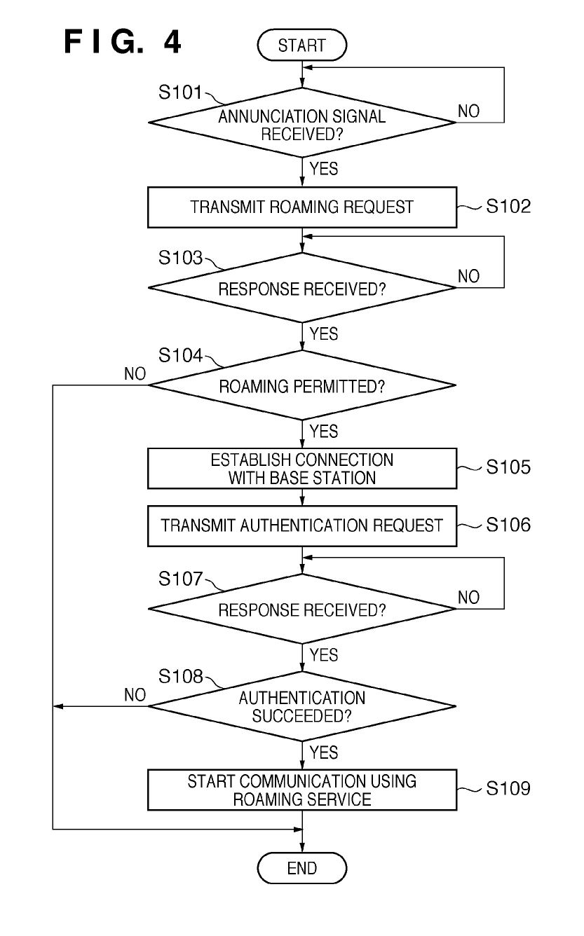

An example of the operation of the communication apparatus 101 shown in FIG. 1 will now be described with reference to FIG. 4. Assume that the user has already set the user subscription information 12a in the communication apparatus 101.

When the annunciation signal reception unit 21 of the communication apparatus 101 receives an annunciation signal from the base station 102, the process starts (YES in step S101). It is possible to receive an annunciation signal when, for example, the communication apparatus 101 enters the electric field strength range of the base station 102. This enables part of physical communications of the communication apparatus 101 with the base station 102. The expression “part of physical communications” indicates, among communications in a MAC layer, communications in which, for example, it is possible to receive an annunciation signal from the base station 102, and transmit/receive a probe request and a probe response to/from the base station 102.

When the communication apparatus 101 receives an annunciation signal, the roaming request transmission unit 22 transmits a roaming request as a probe request to the base station 102 (step S102). As described above, the roaming request contains, for example, user account information (the user subscription information 12a), and the identification information of the communication apparatus 101. The roaming request need not necessarily contain the user subscription information 12a, and instead it is possible to use any information which can identify a user subscription provider. Note that the information which can identify a user subscription provider is preferably information with low confidentiality (for example, a subdomain indicating a user subscription provider). It does not matter whether the information is encrypted or not.

The communication interface 14 of the communication apparatus 101 receives, as a probe response, a response (an inquiry response) to the roaming request. After that, the communication apparatus control unit 11 of the communication apparatus 101 refers to the inquiry response, and then determines whether roaming has been permitted. If, as a result of the determination, roaming is not permitted (NO in step S104), the communication apparatus 101 terminates the process without any further processing.

Alternatively, if roaming is permitted (YES in step S104), the communication apparatus control unit 11 of the communication apparatus 101 establishes connection with the base station 102 to start part of logical communications (step S105). This connection processing uses connection parameters contained in the response which has been received in step S103, and the like, thereby enabling all physical communications and part of logical communications with the base station 102. Note that the part of logical communications indicates, among communications in an IP layer, communications necessary for authentication processing.

After the connection is established, the login execution unit 23 of the communication apparatus 101 executes login authentication processing (step S106). More specifically, the authentication request transmission unit 24 of the communication apparatus 101 transmits an authentication request to the base station 102. Then, when the communication apparatus 101 receives a response to the request (YES in step S107), the login execution unit 23 refers to the response, and determines whether the authentication processing has succeeded or not.

If, as a result of the determination, the authentication processing has failed (NO in step S108), the communication apparatus 101 terminates the process without any further processing. Alternatively, if the authentication processing has succeeded (YES in step S108), the communication interface 14 of the communication apparatus 101 starts communication using the roaming service (step S109).

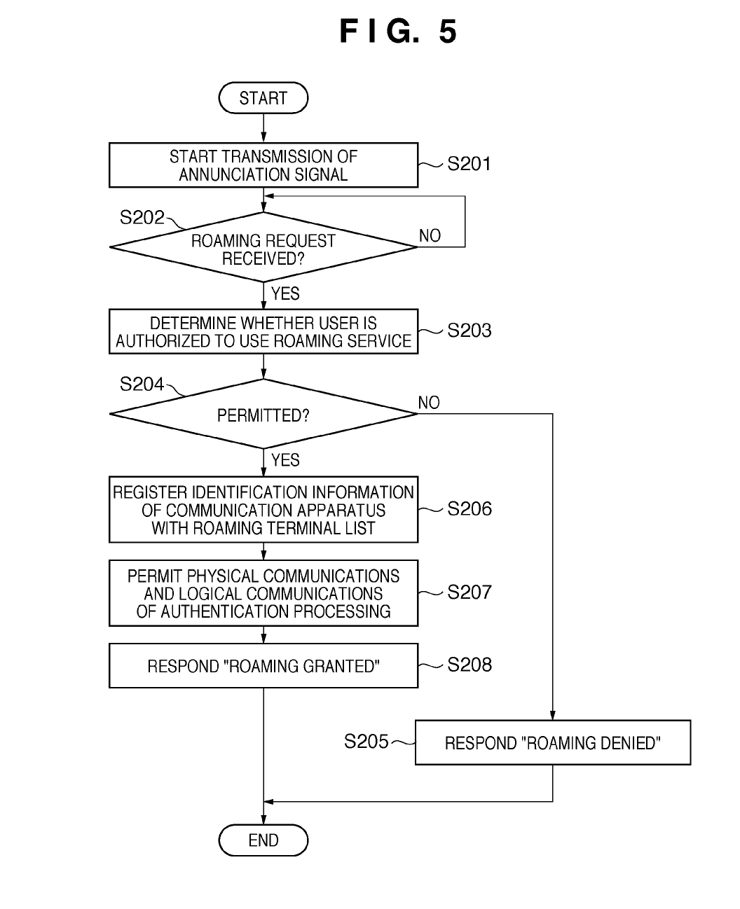

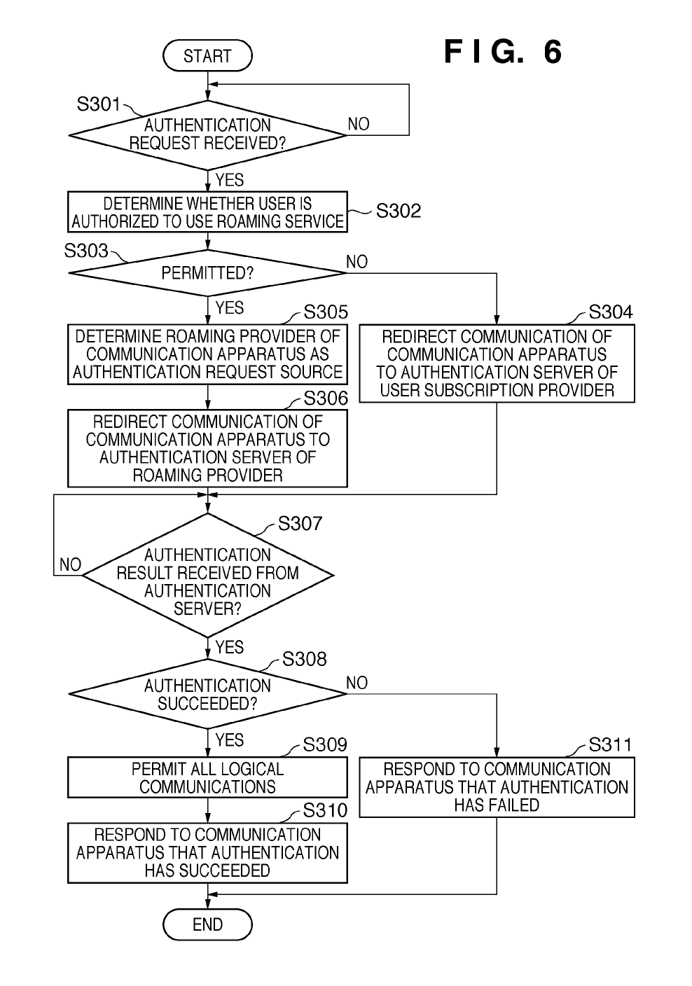

An example of the operation of the base station 102 shown in FIG. 1 will be explained next with reference to FIG. 5.

In the base station 102, the annunciation signal transmission unit 41 starts transmission of an annunciation signal (step S201). When the communication apparatus 101 enters the electric field strength range of the base station 102, the communication apparatus 101 transmits a roaming request to the base station 102. This roaming request is sent as a probe request. As described above, the roaming request contains the user subscription information 12a and the like.

In the base station 102, if the roaming request reception unit 42 receives the roaming request (YES in step S202), the roaming status determination unit 43 determines whether the user of the communication apparatus 101 as a request source is authorized to use the roaming service (step S203). This determination is made based on whether the subscription provider of the user using the communication apparatus 101 matches an entry within the roaming provider list 32a.

If, as a result of the determination, roaming is not permitted, that is, no matching information exists (NO in step S204), the roaming status transmission unit 44 of the base station 102 transmits a response (roaming denied) to step S203 to the communication apparatus 101 (step S205). This response is sent as a probe response. After that, the process ends.

Alternatively, if roaming is permitted, that is, matching information exists (YES in step S204), the identification information management unit 45 of the base station 102 registers the identification information of the communication apparatus 101 as a roaming request source with the roaming terminal list 32b (step S206). As explained above, the identification information of the communication apparatus 101 and a roaming provider corresponding to the apparatus are registered with the roaming terminal list 32b in association with each other. Note that information on the roaming provider is acquired from the roaming provider list 32a.

Upon completion of the registration, the authentication processing control unit 48 of the base station 102 permits all physical communications and part of logical communications (step S207). As described above, the part of logical communications indicates, among communications in the IP layer, communications necessary for authentication processing. In the base station 102, the roaming status transmission unit 44 then transmits, as a probe response (roaming granted), a response to step S203 to the communication apparatus 101 (step S208). As explained above, this response contains connection parameters and the like in addition to the information indicating the roaming service status. Then, the process ends.

An example of the operation of the base station 102 shown in FIG. 1 will now be described with reference to FIG. 6. In step S208 of the process explained above with reference to FIG. 5, this process is executed with the communication apparatus 101 which has been granted roaming.

In the base station 102, if the authentication request reception unit 46 receives an authentication request (YES in step S301), the roaming status determination unit 43 determines whether the user of the communication apparatus 101 as a request source can use the roaming service. This determination is made based on whether the identification information of the communication apparatus 101 as an authentication request source matches an entry within the roaming terminal list 32b.

If, as a result of the determination, roaming is not permitted, that is, no matching information exists (NO in step S303), the user of the communication apparatus 101 is not a user of the roaming service. The redirection unit 49 of the base station 102 redirects communication of the communication apparatus 101 to the authentication server 103 of the user subscription provider (step S304).

Alternatively, if roaming is permitted, that is, matching information exists (YES in step S303), the user of the communication apparatus 101 is a user of the roaming service. The roaming destination determination unit 47 of the base station 102 determines a roaming provider as a roaming destination of the communication apparatus 101 as an authentication request source (step S305). This determination is made based on the identification information of the communication apparatus 101 as an authentication request source contained in the authentication request, and the information held in the roaming terminal list 32b.

Upon determination of a roaming provider, the redirection unit 49 of the base station 102 redirects communication of the communication apparatus 101 to the authentication server 104 of the roaming provider identified by the determination processing (step S306). Based on the authentication request of the communication apparatus 101 redirected from the base station 102, the authentication server 103 or 104 determines whether the authentication processing has succeeded or not. The authentication server transmits an authentication result to the communication apparatus 101. The communication apparatus 101 is notified of the authentication result via the base station 102.

Upon reception of the authentication result from the authentication server 103 or 104 (YES in step S307), the base station 102 refers to the result, and then determines whether the authentication processing of the communication apparatus 101 has succeeded or not. If the authentication processing has succeeded, the base station control unit 31 of the base station 102 permits all logical communications between the communication apparatus 101 and the base station 102 (step S309). The expression “all logical communications” means, in addition to possible communications in “part of logical communications”, all impossible communications in “part of logical communications” such as free access to the Internet. The authentication result transmission unit 50 of the base station 102 then transmits authentication result information (authentication success) to the communication apparatus 101 (step S310). If the authentication processing has failed (NO in step S308), the authentication result transmission unit 50 of the base station 102 transmits authentication result information (authentication failure) to the communication apparatus 101 (step S311). After that, the process ends.

An example of the above-described processing in step S208 of FIG. 5 will be explained. That is, processing which is implemented by the base station 102 to permit all physical communications of the communication apparatus 101 will be briefly described. To start all physical communications with the base station 102, the communication apparatus 101 needs to acquire and set valid connection parameters for the base station 102.

As the first method, there is proposed a method using so-called open authentication. With this method, the communication apparatus 101 acquires connection parameters from an annunciation signal sent from the base station 102. The base station 102, therefore, need not explicitly permit all physical communications of the communication apparatus 101. The communication apparatus 101 determines roaming service status based on the roaming inquiry response.

As the second method, there is provided a method in which the base station 102 encrypts connection parameters, and transmits them to the communication apparatus 101. In this method, the roaming provider list 32a functions as the third holding unit, and holds, in association with each other, a provider to which the self base station (the base station 102) belongs and a provider in roaming service partnership with the provider, and encryption keys. The communication apparatus 101 uses an encryption key set in itself (the communication apparatus 101) to encrypt and transmit a roaming request. Upon reception of the encrypted roaming request, the base station 102 attempts to decode the request by using an encryption key associated with the provider to which the self base station 102 belongs. If the decoding processing has succeeded, the base station 102 transmits a roaming inquiry response (roaming granted) to the communication apparatus 101. If the decoding processing has failed, the base station 102 attempts decoding by using an encryption key held in the roaming provider list 32a. If the decoding processing has succeeded, the base station 102 encrypts connection parameters (for the base station 102) using the encryption key with which the decoding processing has succeeded, contains the encrypted connection parameters in a roaming inquiry response (roaming granted), and transmits the response to the communication apparatus 101. Alternatively, if the decoding processing has failed, the base station 102 transmits a roaming inquiry response (roaming denied) to the communication apparatus 101. Upon reception of the encrypted connection parameters, the communication apparatus 101 uses the encryption key set in itself (the communication apparatus 101) to decode the connection parameters. This enables the communication apparatus 101 to acquire the valid connection parameters for the base station 102.

Using the first and second methods eliminates the need for the user to set, in the communication apparatus 101, the connection parameters necessary for connection to the base station 102.

As described above, according to the embodiment, the user only needs to set in the communication apparatus 101 the user subscription information 12a issued by the user subscription provider in order to use the roaming service. This can simplify a user operation to use the roaming service.

The above embodiment is a representative example of the present invention. The present invention, however, is not limited to the above embodiment shown in the drawings, and modifications can be made as needed without departing from the spirit or scope of the present invention.

For example, the authentication server 103 of the user subscription provider may acquire in advance a certificate of the authentication server 104 of the roaming provider. In this case, if authentication processing of the communication apparatus 101 with the authentication server 103 has succeeded, the authentication server 103 transmits, as an authentication result, information containing the certificate of the authentication server 104 to the communication apparatus 101. With this arrangement, in order to use the roaming service, the communication apparatus 101 executes authentication processing using the authentication server 104 in place of exchanging an annunciation signal, a roaming request and response, and the like with the base station 102. This can simplify authentication processing.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable storage medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-191472 filed on Aug. 20, 2009, which is hereby incorporated by reference herein in its entirety.

What is claimed is:

1. A communication system comprising a base station and a communication apparatus for making communication via said base station,
said communication apparatus comprising:
an authentication request transmission unit configured to transmit, to said base station, an authentication request which contains identification information for identifying said communication apparatus and requests authentication to an authentication server of a roaming provider which provides a roaming service, and
said base station comprising:
a first holding unit configured to hold information which associates identification information of a communication apparatus of a user authorized to use the roaming service with a roaming provider corresponding to the communication apparatus;
a roaming destination determination unit configured to determine a roaming provider as a roaming destination of said communication apparatus as an authentication request source based on the identification information of said communication apparatus as an authentication request source contained in the authentication request, and the information held in said first holding unit; and
a redirection unit configured to redirect communication of said communication apparatus as an authentication request source to an authentication server of the roaming provider determined by said roaming destination determination unit.

2. The system according to claim 1, wherein
said communication apparatus further comprises a roaming request transmission unit configured to transmit, to said base station, a roaming request containing account information of the user using said communication apparatus, and the identification information for identifying said communication apparatus,
said base station further comprises a determination unit configured to determine based on the roaming request whether the user of said communication apparatus as a roaming request source is a user authorized to use the roaming service, and
said first holding unit holds the identification information of said communication apparatus as a roaming request source contained in the roaming request, and the roaming provider corresponding to said communication apparatus in association with each other, if said determination unit determines that the user is authorized to use the roaming service.

3. The system according to claim 2, wherein
the account information is issued by a provider to which the user of said communication apparatus has subscribed,
said base station further comprises a second holding unit configured to hold information indicating a roaming service partnership between the providers, and
said determination unit determines based on the account information contained in the roaming request and the information held in said second holding unit whether the user of said communication apparatus as a roaming request source is a user authorized to use the roaming service.

4. The system according to claim 2, wherein
said base station further comprises a third holding unit configured to hold information that associates, with encryption keys, a provider to which said base station belongs and a provider in roaming service partnership with the provider,
said roaming request transmission unit encrypts the roaming request using an encryption key, and transmits the encrypted roaming request, and
said determination unit determines that the user of said communication apparatus as a roaming request source is a user authorized to use the roaming service, if the encrypted roaming request is successfully decoded by using any one of the encryption keys based on the information held in said third holding unit.

5. The system according to claim 2, wherein
said base station further comprises a transmission unit configured to respond to said communication apparatus as a roaming request source with a determination result from said determination unit, and
said authentication request transmission unit transmits the authentication request to said base station, if said transmission unit responds that roaming is permitted.

6. The system according to claim 2, wherein
said base station further comprises an annunciation signal transmission unit configured to transmit an annunciation signal containing information associated with the roaming, and
said roaming request transmission unit transmits the roaming request to said base station in response to reception of the annunciation signal from said annunciation signal transmission unit.

7. The system according to claim 1, wherein
said base station further comprises an authentication result transmission unit configured to transmit, to said communication apparatus as an authentication request source, authentication result information indicating a result of authentication processing with the authentication server executed in response to redirection by said redirection unit, and
the authentication result information contains a certificate of the authentication server of the roaming provider.

8. A control method for a communication system comprising a base station and a communication apparatus for making communication via the base station, the method comprising:
transmitting, by the communication apparatus, to the base station, an authentication request which contains identification information for identifying the communication apparatus and requests authentication to an authentication server of a roaming provider which provides a roaming service;
holding, by the base station, information which associates identification information of a communication apparatus of a user authorized to use the roaming service with a roaming provider corresponding to the communication apparatus;
determining, by the base station, a roaming provider as a roaming destination of the communication apparatus as an authentication request source based on the identification information of the communication apparatus as an authentication request source contained in the authentication request, and the held information; and
redirecting, by the base station, communication of the communication apparatus as an authentication request source to an authentication server of the roaming provider determined as the roaming destination.

9. A base station for relaying communication of a communication apparatus, comprising:
a first holding unit configured to hold information which associates identification information of a communication apparatus of a user authorized to use a roaming service with a roaming provider corresponding to the communication apparatus;
an authentication request reception unit configured to receive an authentication request which contains identification information for identifying the communication apparatus and requests authentication to an authentication server of a roaming provider which provides the roaming service;
a roaming destination determination unit configured to determine a roaming provider as a roaming destination of the communication apparatus as an authentication request source based on the identification information of the communication apparatus as an authentication request source contained in the authentication request, and the information held in said first holding unit; and
a redirection unit configured to redirect communication of the communication apparatus as an authentication request source to an authentication server of the roaming provider determined by said roaming destination determination unit.

10. The station according to claim 9, further comprising a determination unit configured to determine based on a roaming request from the communication apparatus whether the user of the communication apparatus as a roaming request source is a user authorized to use the roaming service,
wherein said first holding unit holds identification information of the communication apparatus as a roaming request source contained in the roaming request, and a roaming provider corresponding to the communication apparatus in association with each other, if said determination unit determines that the user is authorized to use the roaming service.

11. The station according to claim 10, further comprising a second holding unit configured to hold information indicating a roaming service partnership between the providers,
wherein said determination unit determines based on account information of the user using the communication apparatus contained in the roaming request, and the information held in said second holding unit whether the user of the communication apparatus as a roaming request source is a user authorized to use the roaming service.

12. The station according to claim 10, further comprising a third holding unit configured to hold information that associates, with encryption keys, a provider to which the self base station belongs and a provider in roaming service partnership with the provider,
wherein the communication apparatus encrypts the roaming request using an encryption key, and transmits the encrypted roaming request, and
said determination unit determines that the user of the communication apparatus as a roaming request source is a user authorized to use the roaming service, if the encrypted roaming request is successfully decoded by using any one of the encryption keys based on the information held in said third holding unit.

13. The station according to claim 10, further comprising a transmission unit configured to respond to the communication apparatus as a roaming request source with a determination result from said determination unit.

14. The station according to claim 9, further comprising an annunciation signal transmission unit configured to transmit an annunciation signal containing information associated with the roaming.

15. The station according to claim 9, further comprising an authentication result transmission unit configured to transmit, to the communication apparatus as an authentication request source, authentication result information indicating a result of authentication processing with the authentication server executed in response to redirection by said redirection unit,
wherein the authentication result information contains a certificate of the authentication server of the roaming provider.

16. A computer-readable storage medium storing a computer program for causing a computer incorporated in a base station which relays communication of a communication apparatus to function as:
a first holding unit configured to hold information which associates identification information of a communication apparatus of a user authorized to use a roaming service with a roaming provider corresponding to the communication apparatus;
an authentication request reception unit configured to receive an authentication request which contains identification information for identifying the communication apparatus and requests authentication to an authentication server of a roaming provider which provides the roaming service;
a roaming destination determination unit configured to determine a roaming provider as a roaming destination of the communication apparatus as an authentication request source based on the identification information of the communication apparatus as an authentication request source contained in the authentication request, and the information held in the first holding unit; and
a redirection unit configured to redirect communication of the communication apparatus as an authentication request source to an authentication server of the roaming provider determined by the roaming destination determination unit.
